(19) United States
(12) Patent Application Publication
(10) Pub. No.: US 2018/0001765 A1
(43) Pub. Date: Jan. 4, 2018

(54) DEVICE INTENDED FOR REMOTELY CHANGING THE POWER AND/OR SPEED OF A RECREATIONAL VEHICLE AND TAKING INTO ACCOUNT THE POSITION OF THE ACCELERATOR PEDAL

(71) Applicant: OF COURSE, Biganos (FR)

(72) Inventor: Frederic LANGLET, Pompignac (FR)

(21) Appl. No.: 15/542,811

(22) PCT Filed: Jan. 15, 2016
(86) PCT No.: PCT/FR2016/050070

§ 371 Date: Jul. 11, 2017

(30) Foreign Application Priority Data
Jan. 15, 2015 (FR) 1550301

(51) Int. Cl. B60K 31/00; F02D 41/24; F02D 11/10

(52) U.S. Cl. CPC B60K 31/0058; F02D 11/105; F02D 41/2422; B60W 2710/0622; B60W 2710/0605; B60Y 2200/114; F02D 2200/606; F02D 2400/06

(57) ABSTRACT

A device for remotely changing the control of power generated by an internal combustion engine of a recreational vehicle driven by a driver controlling an accelerator pedal. The device includes a remote control, sending a signal for modulating the power and/or speed of the engine. The device comprises a system for measuring the position of the accelerator pedal, a system for receiving the signal for modulating the power and/or speed, a system for controlling the intake of gases into the engine, and an electronics module connected to the various systems, establishing rules for controlling the intake control system, depending on the position of the accelerator pedal and the received modulation signal.

### CROSS-REFERENCES TO RELATED APPLICATIONS

This application claims the benefit of the French patent application No. 1550301 filed on Jan. 15, 2015, the entire disclosures of which are incorporated herein by way of reference.

### BACKGROUND OF THE INVENTION

The present invention relates to a device for the remote modification of the command for power and/or the speed of an internal combustion engine of a recreational vehicle.

Karts are small, motorized vehicles which are lightweight and economical, which can be driven on circuits easily and with a high degree of safety. For a large number of people, these vehicles are a way of learning to drive during training sessions or races, as well as a pastime and leisure activity which can be pursued individually or in groups.

Karts can be equipped with a two-stroke or four-stroke internal combustion engine. In this case, they have a fixed gear ratio transmission equipped with a clutch with launch control, or with a multi-ratio gearbox. There are also karts having an electric motor.

It is known to install on karts a remote information unit, also called a “transponder”, which is a radio transmitter and receiver that responds to an external signal emitted by a fixed beacon in order to identify and locate the kart on the track, in order, in particular, to record lap times.

In the case of an internal combustion engine, the driver has an accelerator pedal which is generally connected via a cable to a flap opening the gas passage of a carburetor, allowing it to control the quantity of fuel/air mixture admitted into the engine in order to adjust the power delivered. Kart engines can also be supplied by an injection system, in which case the driver issues a command for an air passage flap to be opened, this opening being measured by a computer which establishes the quantity of fuel to be injected. In order to remotely control the maximum speed of the kart, it is known to use a device comprising an electronic unit which is installed on the kart and is connected to the ignition system of the internal combustion engine in order to interrupt this ignition, or to modify the control prior to ignition, which is controlled remotely using a remote control operated by a track steward.

The remote control can, in particular, impose a maximum speed for the kart, for example depending on the level of experience of the driver, or a deceleration profile for this kart, on its last lap in order to arrive in the pits at reduced speed in order to ensure safety, by commanding, at the electronic unit, successive ignition interruptions, or offsetting the advance, which limit the engine speed in accordance with what is desired.

It is, in particular, possible to install fixed beacons in the ground in order to define deceleration zones which are noted by the electronic unit of the kart as it passes over them, in order to automatically command deceleration of the kart at this point in order to make arrival in the pits safer.

However, this type of device which interrupts ignition while the driver is still trying to accelerate results in sudden, successive interruptions in the power delivered by the internal combustion engine, producing powerful and unpleasant vibrations. Changing the ignition advance results in improper combustion of the fuel and increased pollution.

Furthermore, document U.S. Pat. No. 6,876,914 proposes a mechanical system for limiting the gas inlet flap opening in the internal combustion engine, which is controlled remotely by means of a remote control. This simply produces a change in the maximum power available, which leaves a first portion of the travel of the accelerator pedal useful, and renders the second portion of this travel inoperative.

This changes the driving sensations experienced by the driver, with a very different accelerator pedal response. Furthermore, this system does not take into account the real operating conditions of the kart, in particular its speed.

### SUMMARY OF THE INVENTION

The present invention has, in particular, the aim of avoiding these drawbacks of the prior art.

To that end, it proposes a device for the remote modification of the command for power delivered by an internal combustion engine of a recreational vehicle piloted by a driver acting on an accelerator pedal, comprising a remote control which sends a signal for modulating the power and/or the speed, this device comprising a system for measuring the position of the accelerator pedal, a system for receiving the signal for modulating the power and/or the speed, a system for regulating the gas inlet in the engine, and an electronic unit connected to these various systems, establishing rules for controlling the inlet regulation system depending on the position of the accelerator pedal and on the received signal for modulating the power and/or the speed.

One advantage of this modification device is that it is easily possible, depending on the parameters contained in the signal sent by the remote control, to implement all sorts of curves adapting the response of the gas inlet opening by the servomotor, with respect to the position of the accelerator pedal, providing in particular reduced power and/or speed by limiting this opening, while avoiding sudden changes.

Furthermore, it is also possible to keep the full range of movement of the accelerator pedal active, which provides the driver with a good driving sensation in spite of the gas inlet opening being limited, simply by modifying the proportional relationship between these two movements.

The remote modification device according to the invention can further comprise one or more of the following features, which can be combined with one another.

In particular, the modification device may comprise a system for measuring the speed of the internal combustion engine or the speed of the vehicle.

In this case, the electronic unit may take into account the speed of the internal combustion engine or of the vehicle in order to establish the controlling rules. This makes it possible to implement precise closed-loop regulation of the top speed of the vehicle.

Advantageously, the electronic unit establishes controlling rules using the full travel of the accelerator pedal to provide, over all of this travel, a continuously variable response of the gas inlet regulation system. The driving sensations then remain similar

Advantageously, the electronic unit establishes controlling rules that change dynamically depending on received information. This makes it possible to incorporate in real-time parameters such as the position of the vehicle in order to modify the controlling rules.

Preferably, the controlling rules may change depending on the position of the vehicle on a track. This makes it possible to automatically slow the vehicle in order to make safe, for example, a pit approach area or a section of the track.

To that end, at least one beacon that is fixed with respect to the track (for example installed at the edge of the track) transmits a signal for modulating the power and/or the speed to at least one vehicle (and preferably to each vehicle) passing close to the beacon.

Advantageously, the modification device comprises a servomotor for mechanically controlling a flap for the passage of inlet gases.

Advantageously, the modification device comprises a system for measuring the position of the brake pedal. By detecting braking by the driver, it is possible to provide additional safety in the operation of the vehicle.

Advantageously, the measurement systems comprising the positions of the accelerator pedal or the brake pedal, and the speed of rotation of the wheels, comprise Hall effect sensors. This type of sensor is simple and cost-effective.

Advantageously, the system for receiving the modulation signal is integrated into the electronic unit. This makes use of a single unit integrating multiple common functions.

Advantageously, the electronic unit comprises means for displaying information received during operation of the vehicle. It is possible to follow the operation during a session, either after-the-fact or in real-time from outside the vehicle.

In this case, the electronic unit may comprise means for sending information to the remote control.

The electronic unit may also comprise a port intended for connecting to an external computer, which makes it possible in particular to display information received during operation of the vehicle.

### BRIEF DESCRIPTION OF THE DRAWINGS

Other features and advantages will emerge from the following description of the invention, which description is provided purely by way of example, with reference to the appended drawings, in which:

FIG. 1 shows a kart driving on a track, equipped with a modulating device according to the invention; and

FIG. 2 is a diagram of the connections of the electronic management unit of this device.

### DETAILED DESCRIPTION OF THE PREFERRED EMBODIMENTS

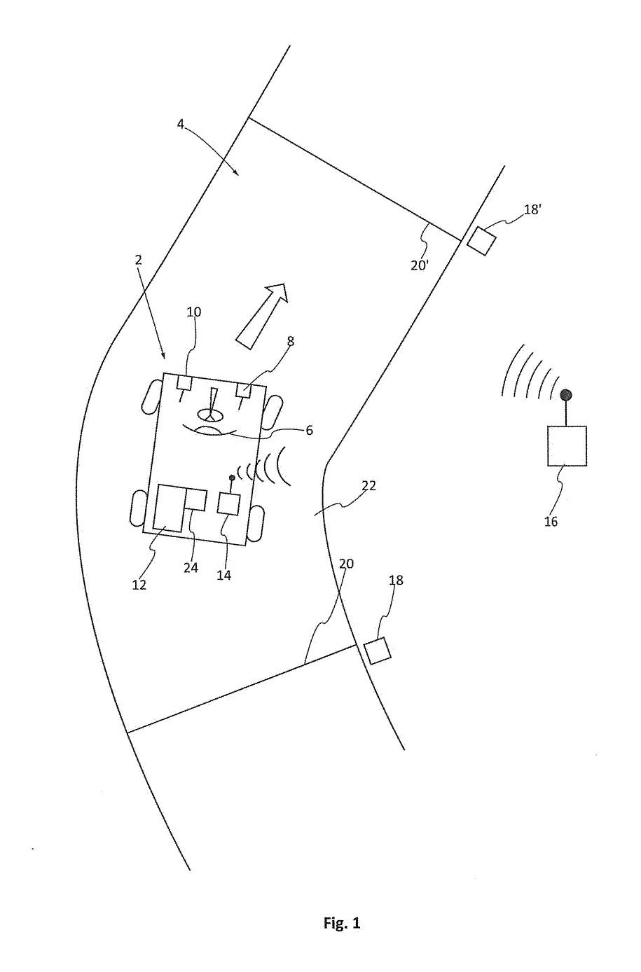

FIG. 1 shows a kart 2 driving on a track 4, piloted by a driver 6 acting on an accelerator pedal 8 located on the right, and on a brake pedal 10 located on the left.

The internal combustion engine 12, which is arranged at the rear and directly drives a transverse shaft connecting the two rear wheels, comprises a gas inlet regulation flap which is controlled by the accelerator pedal 8.

The kart 2 comprises an electronic management unit 14 which receives a power and/or speed modulation signal sent by a remote control 16 located at the edge of the track in order to command, depending on the position of the accelerator pedal 8, a servomotor 24 that controls the gas inlet opening in order to remotely change the maximum power and/or the maximum speed delivered by the internal combustion engine 12.

The remote control 16 can be operated manually by a track steward, or automatically by a computer.

Preferably, the electronic management unit 14 comprises, in addition to a system for receiving a signal, a system for transmitting a signal that can remotely send information to the remote control 16 or to another receiver. Preferably, the receiving and transmitting systems operate at the same power. According to one preferred embodiment, the electronic management unit 14 comprises a single transmitting and receiving system.

In order to limit the electrical power consumption of the electronic management unit 14, reception and transmission of signals is not permanent.

According to one embodiment, the device comprises at least one fixed beacon 18 installed on, in or close to the track 4. According to one embodiment, which is shown in FIG. 1, the device comprises multiple fixed beacons 18, 18′ which delimit a section of track 22. Each fixed beacon 18, 18′ is configured to transmit a power and/or speed modulation signal to at least one kart 2 passing close to the fixed beacon 18, 18′. Preferably, each beacon is configured to transmit a power and/or speed modulation signal to each kart 2 passing close by. This makes it possible to regulate the power and/or the speed of each kart 2 for each section of the track, each section 22 being delimited by an upstream virtual line 20 and a downstream virtual line 20′, each corresponding to the passage of the karts 2 respectively close to a beacon 18 at the entrance to the section 22 and a beacon 18′ at the exit from the section 22.

According to one operating principle, each fixed beacon 18, 18′ transmits at least one short-range signal which can be picked up only by the karts passing close to the fixed beacon 18, 18′.

The power and/or speed modulation signal transmitted by each fixed beacon 18, 18′ can be time-invariant. According to one preferred mode of operation, the power and/or speed modulation signal transmitted by each fixed beacon 18, 18′ varies. Thus, the remote control 16 can send, to at least one fixed beacon 18, 18′, a power and/or speed modulation signal that is transmitted by the fixed beacon 18, 18′ to at least one kart and preferably to all karts passing close to the fixed beacon 18, 18′.

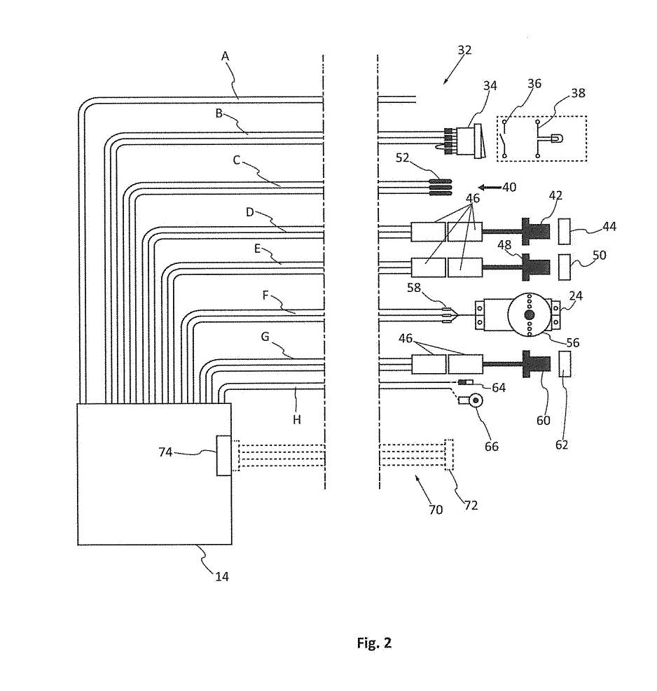

FIG. 2 shows the electronic management unit 14 connected to a set of electric wires forming multiple bundles, which will be described hereinbelow starting at the top.

The first bundle A comprises two wires connected to two poles of an electrical power supply supplying direct current 32. The electrical power supply can, in particular, provide a current at a nominal voltage of 12 V, which is in practice between 9 V and 14 V, with a maximum power of 20 W.

The second bundle B comprises three wires connected to a pushbutton 34 (which comprises a switch 36) and to an indicator 38. According to one mode of operation, the electronic management unit 14 comprises an auto switch-on system which can activate it when the engine 12 of the kart 2 is started up. If necessary, the pushbutton 34 can be used to activate the electronic management unit 14.

The third bundle C comprises three wires connected to a multiplexing network 40 for several functions of the kart, which can, in particular, use the “CAN bus” technology frequently used in motor vehicles.

The third bundle C is connected to the multiplexing network 40 by electrical connections which are advantageously covered by a heat-shrinkable sleeve 52 in order to protect these connections.

The fourth bundle D comprises three wires connected by two connection plugs 46 to a Hall effect braking sensor 42 which measures the displacement of a magnet 44 connected to the brake pedal 10 of the kart in order to register movements of this pedal commanded by the driver. It is possible, in particular, to detect a level of braking desired by the driver.

Similarly, the fifth bundle E comprises three wires connected by two connection plugs 46 to a Hall effect acceleration sensor 48 which measures the displacement of a magnet 50 connected to the accelerator pedal 8 of the kart in order to register movements of this pedal commanded by the driver.

In particular, the position of the accelerator pedal 8 is measured with sufficient precision to know the level of power desired by the driver.

The sixth bundle F comprises three wires connected, by electrical connections advantageously covered by a thermo-adhesive sleeve 58 in order to protect these connections, to the servomotor 24 comprising a rotating disk 56 onto which can be attached a rod for controlling the gas inlet flap in the internal combustion engine.

The gas inlet flap may be of various types. In particular, in the case of a carburetor, it can form a butterfly valve pivoting about an axis arranged in the gas passage, or a cylindrical or flat sliding gate which slides transversely with respect to this passage in order to close it. The gas inlet flap can also be a flap that controls only the ingress of air, in the case of an injection engine.

The seventh bundle G comprises three wires connected by two connection plugs 46 to a Hall effect sensor 60 which detects the displacement of four magnets 62 distributed around the rear wheel shaft driven by the engine 12.

Thus, the frequency of the signal given by the magnets 62, divided by the number of magnets, directly gives the speed of rotation of the shaft of the wheels. Then, taking into account the circumference of the rear wheels gives the speed of the kart.

It is to be noted that this technology, arranging detection means directly on the wheel shaft, makes it possible to know the speed of the kart without using information from the ignition of the engine and giving the speed of this engine, which would not be sufficient in the case of a transmission comprising various gear ratios.

As a variant, for a kart equipped with an engine having a single gear ratio, it is then possible to directly take the speed information of this engine, in particular at the ignition, and to obtain, taking into account the single reduction ratio, the rotational speed of the shaft of the wheels.

The eighth bundle H comprises two wires. A first wire is connected by means of a plug 64 to the primary circuit of the high-voltage ignition coil of the engine, which provides information on the speed of this engine. A second wire comprises a ring terminal 66 which is designed to receive a screw for attachment to the mass of the engine, in order to earth the electronic management unit 14.

The electronic management unit 14 further comprises a port 74 that is intended to receive an adapter cable 70 comprising an end plug 72 which connects to a computer, in order to be able to read the information in this unit, or to program the unit.

The electronic management unit 14 comprises a radio receiver that receives the modulation signal sent by the remote control 16.

Operation of the remote modification device is as follows.

The electronic unit 14 comprises various programmed controlling rules, each resulting in a different response from the control of the servomotor 24, and thus from the opening of the gas passage, depending on the position of the accelerator pedal 8 measured by the Hall effect acceleration sensor 48. In particular, the programmed controlling rules can be dynamic in order to produce, for example, progressive braking of the kart over a defined zone, and if necessary stop it at a specific point.

The operator or the computer in charge of the remote control 16 can thus exercise complete control, at a distance, of the power and/or the speed of the kart, in order in particular to ensure safety.

During normal operation, when the function of remotely changing the power command is not activated, the electronic management unit 14 uses a normal controlling rule which controls a regular opening of the gas passage as a function of the degree to which the accelerator pedal 8 is pressed, such that this passage is fully open when the pedal is fully pressed.

It will be noted that, between the two end positions of the accelerator pedal 8, in which the gas passage is respectively essentially closed and completely open, the opening rule, which is not necessarily linear, can be freely adjusted in order to improve precision or comfort.

The driver then has at their disposal the maximum power and/or speed of the motor, with no limitation.

When the function of remotely changing the power and/or speed command is activated, the electronic management unit 14 uses various particular controlling rules of the servomotor 24, which depend on the modulation signal sent by the remote control 16 located at the edge of the track.

These include, in particular, the normal operating rule which allows the driver to use maximum engine power. These also include various controlling rules each applying one type of limitation, in particular a fixed limit on the maximum power or the speed of the internal combustion engine or of the kart, or a variable limit which restricts the power or the speed to a variable value, producing for example progressive deceleration prior to stopping.

Advantageously, the controlling rules maintain variation in the power available over the entire travel of the accelerator pedal 8, modifying the proportional relationship between this pedal travel and the permitted opening range of the gas inlet, in order to provide the driver with similar sensations using the full travel of the pedal.

The limiting rule can be dynamic, changing in real time depending on received information, for example depending on the position of the kart in question or the positions of the other karts, or depending on external circumstances such as rain which reduces grip on the track.

In particular, a beacon 18 can be used to impose a speed reduction on the karts passing close to the beacon 18. It is also possible to use action on the brake pedal 10, measured by its sensor 42, to limit the power delivered by the internal combustion engine 12 in order to avoid incorrect maneuvers.

The control of the servomotor 24 can, in particular, take into account, in return, reactions of the kart measured in real time, in particular the speed of the internal combustion engine 12 or the speed of this kart, in order to carry out closed-loop regulation involving correction of the setpoint given to the servomotor 24, in order to obtain the corresponding control of the gas inlet at a desired speed.

Furthermore, the remote modification device can also propose another function which requires no additional material, is cost-effective and provides, in real time or after the fact, information on the operation of the kart, which is recorded by the electronic unit 14.

This information can be read after the fact by connecting a computer to the port 74 of the electronic unit 14, after the kart has been driven. It can also be transmitted in real time by the electronic unit 14 comprising a transmitter, to be read by the operator or the computer in charge of the remote control 16.

Connecting a computer to the port 74 also makes it possible to reprogram the electronic unit 14.

This makes it possible to receive and record information on the operation of each kart on the track, in particular its maximum speed or power, or its speed profile around the circuit. This function can serve, for example, to check the state of the karts, or can be used as a teaching resource to help the drivers improve.

It will be noted that the device for the remote modification of the power and/or speed command, according to the invention, can be used in various types of vehicles driving in a given location, such as all-terrain karts, or other types of four-wheeled or two-wheeled vehicles which comprise regulation of the gas inlet in the engine, and which can go around a track.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1-14. (canceled)

15. A device for the remote modification of the command for power delivered by an internal combustion engine of a recreational vehicle driven by a driver acting on an accelerator pedal, comprising:
a remote control configured to send a signal for modulating at least one of the power or a speed of the engine,
a system for measuring the position of the accelerator pedal,
a system for receiving the signal for modulating the at least one of the power or the speed,
a system for regulating the gas inlet in the engine, and
an electronic unit connected to these various systems, the electronic unit configured to establish rules for controlling the inlet regulation system depending on the position of the accelerator pedal and on the received signal for modulating the at least one of the power or the speed.

16. The modification device as claimed in claim 15, further comprising a system for measuring one of the speed of the internal combustion engine or a speed of the vehicle.

17. The modification device as claimed in claim 16, wherein the electronic unit takes into account the speed of the internal combustion engine or the speed of the vehicle in order to establish the controlling rules.

18. The modification device as claimed in claim 15, wherein the electronic unit establishes controlling rules using the full travel of the accelerator pedal to provide, over all of this travel, a continuously variable response of the gas inlet regulation system.

19. The modification device as claimed in claim 15, wherein the electronic unit establishes controlling rules that change dynamically depending on received information.

20. The modification device as claimed in claim 19, wherein the controlling rules change depending on the position of the vehicle on a track.

21. The modification device as claimed in claim 20, further comprising at least one beacon fixed with respect to the track, and configured to transmit a signal for modulating the at least one of the power or the speed to at least one vehicle passing close to said beacon.

22. The modification device as claimed in claim 15, further comprising a servomotor for mechanically controlling a flap for the passage of inlet gases.

23. The modification device as claimed in claim 15, further comprising a system for measuring the position of the brake pedal.

24. The modification device as claimed in claim 23, wherein the system for measuring the position of the brake pedal comprises at least one Hall effect sensor.

25. The modification device as claimed in claim 15, wherein the system for receiving the modulation signal is integrated into the electronic unit.

26. The modification device as claimed in claim 15, wherein the electronic unit comprises a display configured to display information received during operation of the vehicle.

27. The modification device as claimed in claim 26, wherein the electronic unit comprises means for sending information to the remote control.

28. The modification device as claimed in claim 26, wherein the electronic unit comprises a port configured to connect to an external computer.

29. The modification device as claimed in claim 15, wherein the system for measuring the position of the accelerator pedal comprise at least one Hall effect sensor.

30. The modification device as claimed in claim 15, further including a system for measuring a speed of rotation of wheels of the vehicle which comprises at least one Hall effect sensor.
